(19) United States
(12) Patent Application Publication
(10) Pub. No.: US 2007/0018989 A1
(43) Pub. Date: Jan. 25, 2007

(54) Sensory integration therapy system and associated method of use

(75) Inventors: Greg Roberts, Alpharetta, GA (US); Suzanne Roberts, Alpharetta, GA (US)

Correspondence Address: DOUGHERTY CLEMENTS, 1901 ROXBOROUGH ROAD, SUITE 300, CHARLOTTE, NC, 28211, US

(73) Assignee: Playmotion, LLC

(21) Appl. No.: 11/489,412

(22) Filed: Jul. 19, 2006

Related U.S. Application Data
(60) Provisional application No. 60/700,827, filed on Jul. 20, 2005.

(51) Int. Cl. G06T 15/70

(52) U.S. Cl. 345/473

(57) ABSTRACT

A sensory integration therapy system and method in the treatment of developmental, emotional, psychiatric, and physical disabilities is provided. The system includes an image generator for creating or projecting an artistic image, optionally, a display medium for displaying the artistic image, and one or more illumination energy devices for flooding a field of view in front of the artistic image with illumination energy and an image sensor for detecting the illumination energy. The system includes a computer vision engine for detecting the user(s) in front of the artistic image and segmenting the user(s) and a background, thereby providing markerless or markered motion capture, a computer interaction engine for inserting an abstraction related to the user(s) and/or the background, and a computer rendering engine for modifying the artistic image in response to the presence and/or motion of the user(s), providing user interaction with the artistic image in a virtual environment.

### CROSS-REFERENCE TO RELATED APPLICATION(S)

The present non-provisional patent application claims the benefit of priority of U.S. Provisional Patent Application No. 60/700,827, entitled “SENSORY INTEGRATION THERAPY SYSTEM AND ASSOCIATED METHOD OF USE,” and filed on Jul. 20, 2005, which is incorporated in full by reference herein.

### FIELD OF THE INVENTION

The present invention relates generally to the fields of interactive imaging and sensory integration and habilitative therapy, as well as rehabilitative therapy. More specifically, the present invention relates to a sensory integration therapy system and an associated method of use for the treatment of developmental, emotional, psychiatric, and physical disabilities.

### BACKGROUND OF THE INVENTION

Sensory integration theory deals with the way the human body interprets and integrates sensory input. Sensory integration is the human body's ability to perceive information through various sensory inputs (i.e., the senses of touch, movement, smell, taste, vision, and hearing), and to combine the resulting perceptions with prior information, memories, and knowledge already stored in the brain, in order to derive coherent meaning from processing the newer sensory input.

In some cases, the way the human body processes, organizes, and integrates sensory input is impaired, resulting from or causing developmental, emotional, psychiatric, and physical disabilities, such as autism, attention-deficit hyperactivity disorder, and fragile X syndrome. In such cases, a sensory integration disorder, caused by inefficient neurological processing, prevents an appropriate and automatic response to sensory input, creating a “fright-flight-fight” or “withdrawal” response (sensory defensiveness), often appearing inappropriate and extreme in a given situation. Thus, sensory information is sensed normally, but perceived abnormally. Signs of such a disability include oversensitivity or under-reactivity to touch, movement, sight, or sound; difficulty in transitioning from one situation to another; limited attention control; social and/or emotional problems; poor body awareness; etc.

A primary way in which the conditions of sensory integration disorders are often treated is using occupational therapy. An occupational therapist, for example, might evaluate how a child perceives sensation of various senses (i.e., see, touch, taste, smell, hear) in a sensory-enriched exercise room or sports center. Such occupational therapy can facilitate the progress of the nervous system's ability to process sensory inputs. Other methods for treating the conditions of sensory integration disorders include auditory simulation therapies, nutritional therapies, osteopathic manipulation, hippotherapy, integrated therapies, and phototherapy.

One promising treatment for sensory integration disorders involves selective and planned sensory stimulation, which teaches the human body to properly process, organize, and integrate sensory input. For example, selective and planned touching can be used to treat tactile oversensitivity and visual stimulation can be used to treat visual sensory overload. Typically, these treatments are conducted in the absence of other sensory inputs. For example, visual stimulation is preferably conducted in the absence of tactile stimulation.

### BRIEF SUMMARY OF THE INVENTION

In various exemplary embodiments, the present invention provides a sensory integration therapy system and method for use in the treatment of developmental, emotional, psychiatric, and physical disabilities.

In one exemplary embodiment of the present invention, a sensory integration therapy system for use in the treatment of developmental, emotional, psychiatric, and physical disabilities includes an image generator operable for creating or projecting an artistic image and, optionally, a display medium operable for receiving and displaying the created or projected artistic image. The system also includes one or more illumination energy devices operable for flooding a field of view in front of the created or projected artistic image with illumination energy and an image sensor operable for detecting the illumination energy. The system further includes a computer vision engine operable for detecting one or more users in the field of view in front of the created or projected artistic image and segmenting the one or more users and a background, thereby providing markerless or markered motion capture, a computer interaction engine operable for inserting an abstraction related to the one or more users and/or the background, and a computer rendering engine operable for modifying the created or projected artistic image in response to the presence and/or motion of the one or more users, thereby providing user interaction with the created or projected artistic image in a virtual environment. Optionally, the computer vision engine, the computer interaction engine, and the computer rendering engine are program components within a runtime software environment operating on a personal computer.

In another exemplary embodiment of the present invention, a sensory integration therapy method for use in the treatment of developmental, emotional, psychiatric, and physical disabilities includes providing an image generator operable for creating or projecting an artistic image and, optionally, providing a display medium operable for receiving and displaying the created or projected artistic image. The method also includes providing one or more illumination energy devices operable for flooding a field of view in front of the created or projected artistic image with illumination energy and providing an image sensor operable for detecting the illumination energy. The method further includes providing a computer vision engine operable for detecting one or more users in the field of view in front of the created or projected artistic image and segmenting the one or more users and a background, thereby providing markerless or markered motion capture, providing a computer interaction engine operable for inserting an abstraction related to the one or more users and/or the background, and providing a computer rendering engine operable for modifying the created or projected artistic image in response to the presence and/or motion of the one or more users, thereby providing user interaction with the created or projected artistic image in a virtual environment. Optionally, the computer vision engine, the computer interaction engine, and the computer rendering engine are program components within a runtime software environment operating on a personal computer.

In a further exemplary embodiment of the present invention, a sensory integration therapy method for use in the treatment of developmental, emotional, psychiatric, and physical disabilities includes creating or projecting an artistic image; detecting one or more users in a field of view in front of the created or projected artistic image and segmenting the one or more users and a background, thereby providing markerless or markered motion capture; and modifying the created or projected artistic image in response to the presence and/or motion of the one or more users, thereby providing user interaction with the created or projected artistic image in a virtual environment.

In a still further exemplary embodiment of the present invention, a sensory integration therapy method for use in the treatment of developmental, emotional, psychiatric, and physical disabilities includes creating or projecting an artistic image; detecting one or more users in a field of view in front of the created or projected artistic image and segmenting the one or more users and a background, thereby providing markerless or markered motion capture; and modifying the created or projected artistic image in response to the presence and/or motion of the one or more users, thereby providing user interaction with each other in a virtual environment.

In a still further exemplary embodiment of the present invention, a sensory integration therapy system for use in the treatment of developmental, emotional, psychiatric, and physical disabilities includes an image generator operable for creating or projecting an artistic image; optionally, a display medium operable for receiving and displaying the created or projected artistic image; one or more illumination energy devices operable for flooding a field of view in front of the created or projected artistic image with illumination energy; an image sensor operable for detecting the illumination energy; a computer vision engine operable for detecting one or more users in the field of view in front of the created or projected artistic image and segmenting the one or more users and a background, thereby providing markerless or markered motion capture; a computer interaction engine operable for inserting an abstraction related to the one or more users and/or the background; a computer rendering engine operable for modifying the created or projected artistic image in response to the presence and/or motion of the one or more users, thereby providing user interaction with the created or projected artistic image in a virtual environment; and a physical input and/or output device operable for allowing the one or more users to physically interact with the created or projected artistic image and/or each other in the virtual environment. Optionally, the computer vision engine, the computer interaction engine, and the computer rendering engine are program components within a runtime software environment operating on a personal computer.

There has thus been outlined, rather broadly, the features of the present invention in order that the detailed description that follows may be better understood, and in order that the present contribution to the art may be better appreciated. There are additional features of the invention that will be described and which will form the subject matter of the claims. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Additional aspects and advantages of the present invention will be apparent from the following detailed description of exemplary embodiments which are illustrated in the accompanying drawings.

### BRIEF DESCRIPTION OF THE DRAWINGS

The present invention is illustrated and described herein with reference to various figures, in which like reference numerals denote like system components and/or method steps, and in which:

FIG. 1 is a schematic diagram illustrating one exemplary embodiment of the sensory integration therapy system of the present invention;

FIG. 2 is a flow chart illustrating one exemplary embodiment of the sensory integration therapy method of the present invention; and

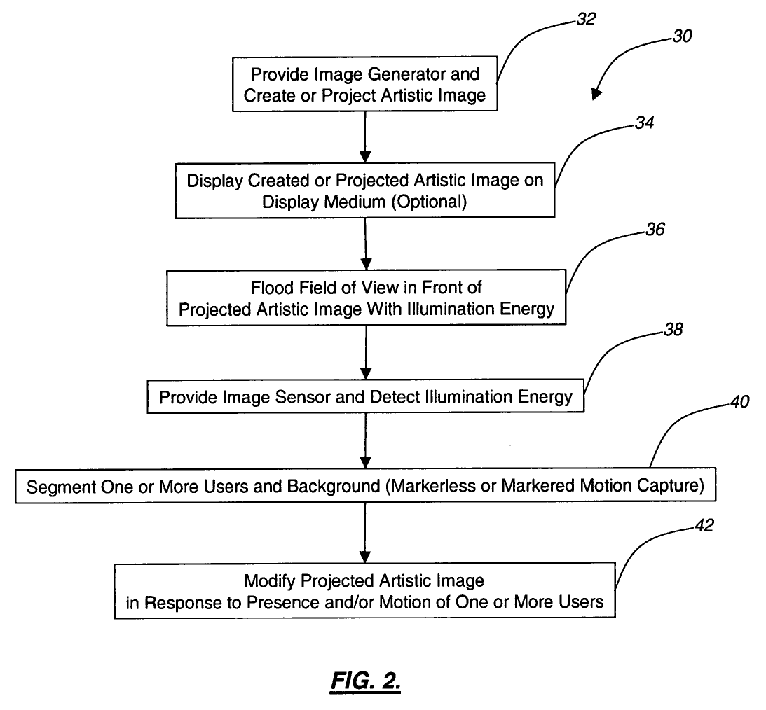

FIG. 3 is a schematic diagram illustrating the sensory integration therapy system of the present invention and a user's rehabilitative therapy interactive imaging experience.

### DETAILED DESCRIPTION OF THE INVENTION

Before describing the disclosed embodiments of the present invention in detail, it is to be understood that the invention is not limited in its application to the details of the particular arrangement shown here since the invention is capable of other embodiments. Also, the terminology used herein is for the purpose of description and not of limitation.

The sensory integration therapy system of the present invention utilizes an image generator (such as a visible light projector or the like), optionally, a display medium (such as a projection screen or the like), one or more illumination energy devices (such as one or more infrared lights or the like), an image sensor (such as an infrared camera or the like), a computer vision engine, a computer interaction engine, and a computer rendering engine to create or project images and allow one or more users to interact with them (and, optionally, with each other) in real time in a virtual environment. For example, a user standing in front of a projection screen may move his or her shadow and make it interact with projected waves, vapor trails, pool balls, etc. In this manner, visual (and optionally auditory) stimulation is provided in the absence of tactile stimulation. Tactile stimulation may also be provided in a staged manner through the use of a physical input and/or output device. This system has tremendous potential for use in the field of sensory integration and habilitative therapy, as well as rehabilitative therapy, as is described in greater detail herein below.

In various exemplary embodiments, the present invention provides a sensory integration therapy system and method for use in the treatment of developmental, emotional, psychiatric, and physical disabilities.

In one exemplary embodiment of the present invention, a sensory integration therapy system 10 for use in the treatment of developmental, emotional, psychiatric, and physical disabilities includes an image generator 12 operable for creating or projecting an artistic image. The image generator 12 is, for example, a visible light projector or the like. Various artistic images that are projected one at a time include, but are not limited to, water, where movement of a user's body sends realistic waves and ripples through a sheet of liquid fun; smoke fireballs, where a user's body may inject billowing smoke into the air and shoot fireballs from outstretched hands; trees, where a user enjoys a sublime experience in creating realistic limbs, branches, and twigs from the body and outstretched arms, transforming one temporarily into a beautiful tree; and a solar system, where a user may imagine the body as a titan while manipulating planets with outstretched arms and hands. Other artistic images that are projected may include, but are not limited to, billiards, revelation images, a mesmerizing spectrum, a shufflepuck game, a soccer game, a volleyball game, snowman creation, snowball fight, and an avalanche of balls.

In one embodiment the image generator 12 is a NEC MT 1075 multi-purpose projection system. The NEC MT 1075 multi-purpose projection system is known in the art and is commercially available. This image generator 12 includes a power zoom/focus lens and a 300-watt lamp and produces an image size between 25 inches and 500 inches. This image generator 12 has an exceptional brightness level of 4,200 ANSI lumens, auto focus, auto wall color correction, and auto 3D reform, each making the interactive imaging experience more realistic for the sensory integration user undergoing habilitative therapy or rehabilitative therapy. Furthermore, this image generator 12 has an array of input and output terminals for quick and easy connectivity with other components of the overall sensory integration therapy system 10. For example, the image generator 12 includes a digital visual interface digital only (DVI-D) port with which a DVI cable connects the image generator 12 to the computer vision engine 22, computer interaction engine 25, and computer rendering engine 26. In addition to the array of input and output terminals, this image generator 12 may be controlled wirelessly from a remote control device and also optionally connects wirelessly to the computer vision engine 22, computer interaction engine 25, and computer rendering engine 26.

Optionally, the sensory integration therapy system 10 also includes a display medium 14 operable for receiving and displaying the created or projected artistic image. The display medium 14 in one embodiment consists of a two or three-dimensional projection screen, a wall or other flat surface, a plasma screen, a rear-projection system, a hyper-bright OLED surface (possibly sprayed-on as a flexible substrate and onto the surface of which images are digitally driven), or the like. In general, the system 10 is display agnostic.

The sensory integration therapy system 10 further includes one or more illumination energy devices 16 operable for flooding a field of view in front of the created or projected artistic image with illumination energy. For example, the one or more illumination energy devices 16 in one embodiment consists of one or more infrared lights operable for flooding the field of view in front of the created or projected artistic image with infrared light of a wavelength of between about 700 nm and about 1,000 nm. Preferably, the infrared light consists of near-infrared light of a wavelength of between about 700 nm and about 1,000 nm. Optionally, the infrared light consists of structured (patterned) infrared light or structured (patterned) and strobed infrared light, produced via light-emitting diodes (LEDs) or the like. In an alternative exemplary embodiment of the present invention, the image generator 12 and the one or more illumination energy devices 16 are integrally formed and utilize a common illumination energy source.

In one embodiment the illumination energy devices 16 are Lorex™ model VQ2120 infrared LED lamps. The Lorex™ model VQ2120 infrared LED lamp system is known in the art and is commercially available. A Lorex™ model VQ2120 infrared LED lamp system includes a sixty-eight power, 0 Lux, infrared LED lamp (comprises 68 LED illumination sensors), a 700 mA, 12-volt DC power source, a “Y” connector, and a mounting system. The “Y” connector allows a user to split the 12-volt DC power source between multiple illumination energy devices 16. The Lorex™ model VQ2120 infrared LED lamps emit infrared light at a wavelength of 850 nm (75 mm diameter), covering an illumination angle of approximately fifty to sixty degrees. The 12-volt DC power source plugs into a commercial electrical source. The “Y” connector's DC plug connects to the other end of the 12-volt DC power source. One or more infrared LED lamps are then plugged into the “Y” connector using the IN jack on each infrared LED lamp. A single infrared LED lamp is connected to the 12-volt DC power source without using the “Y” connector. These components comprise the illumination energy devices 16 used in the sensory integration therapy system 10 in this embodiment. The illumination energy devices 16 do not connect to the image sensor 18; however, optimal performance is obtained when the illumination energy devices 16 are placed a close as possible as the image sensor 18, and pointing in the same direction as the image sensor 18.

The sensory integration therapy system 10 still further includes an image sensor 18 operable for detecting the illumination energy. The image sensor 18 is, for example, an infrared camera or the like. In an alternative exemplary embodiment of the present invention, the image generator 12 and the image sensor 18 are integrally formed.

In one embodiment the image sensor 18 is a Lumenera Corporation Lu070 high speed USB 2.0 (480 Mbits/sec) camera. The Lumenera Corporation Lu070 camera is known in the art and is commercially available. This image sensor 18 captures images at 60 frames per second at a resolution of 640×480 pixels, 7.4 um square pixels. The image sensor 18 is based on a one-third inch, 5.8 mm×4.9 mm array, charge-coupled device (CCD) sensor with a fast global electronic shutter, which is ideal for capturing objects in motion in an interactive imaging experience. This image sensor 18 ideally maintains low light sensitivity to provide image capture even in low light conditions. This is ideal in a sensory integration therapy system 10 wherein the lighting is optionally and intentionally low in order to provide better viewing of the projected images on the display medium 14. The image sensor 18 connects to the computer vision engine 22, computer interaction engine 25, and computer rendering engine 26 via a high-speed USB 2.0 (480 Mbits/sec) connector.

Optionally, an optical filter 20 is coupled with the image sensor 18 and is operable for filtering out illumination energy of a predetermined wavelength or wavelength range, such as, for example, visible light.

In one embodiment the optical filter 20 is an X-Nite 780 nm×2 mm thick infrared band pass, visible light blocking filter, in 30 mm diameter. This X-Nite 780 mn, 30 mm optical filter 20 is known in the art and is commercially available. The optical filter 20 is constructed of optical precision ground and polished glass that is ISO2002 compliant. Such an optical filter 20 blocks all light in the visible spectrum and only allows a band of infrared light to pass. The threshold cutoff value for what light passes is the 780 nm wavelength.

The sensory integration therapy system 10 still further includes a computer vision engine 22 operable for detecting one or more users 24 in the field of view in front of the created or projected artistic image and segmenting (using segmentation algorithms) the one or more users 24 and a background, thereby providing markerless or markered motion capture. The computer vision engine 22 is optionally a program component within a runtime software environment operating on a personal computer, or the like, having an operating system. The computer vision engine 22 gives the system 10 “sight” and provides an abstraction of the one or more users 24 and the background. In this manner, the one or more users 24 and the background are separated and recognized (segmented through a segmentation algorithm). When properly implemented, the number of users 24 can be determined, even if there is overlap, and heads and hands may be tracked. Preferably, all of this takes place in real time, i.e. between about 1/30^{th} and 1/60^{th} of a second.

Segmentation, generally, has to do with image processing. Segmentation is a technique concerned with splitting up an image, or visual display, into segments or regions, each segment or region holding properties distinct from the areas adjacent to it. This is often done using a binary mask, representing the presence of a foreground object in front of the visual display surface.

A conceptual example of this definition of segmentation is the image formed on an all-white front-projected visual display when a person, or the like, is placed in front of the visual display and casts a shadow upon it. In this example, only the black or shadowed region of the visual display, as viewed on a wall, projection screen, or the like, denotes the presence of a foreground element, a body or similar object, and the white color in the visual display denotes background or non-presence of a foreground object. Normally, however, this segmentation is a binary image representation that is computed using a monochrome camera input.

There are a number of segmentation techniques, or algorithms, which are already well known in the art. Two of these segmentation techniques include background subtraction and stereo disparity-based foreground detection, both of which may be employed for generating a segmentation image.

A common approach for generating segmentation images from a camera that faces a visual display is to filter the camera to observe only near-infrared light while ensuring that the display only emits visible, non-infrared light. By separating the sensing spectrum from the display spectrum, the problem is reduced from detecting foreground elements in a dynamic environment created by a changing display to the problem of detecting foreground elements in a static environment, similar to chroma-key compositing systems with green or blue screens.

Optionally, the computer vision engine 22 is operable for detecting the one or more users 24 in the field of view in front of the created or projected artistic image and segmenting the one or more users 24 and the background, thereby providing markerless or markered motion capture, utilizing the parallax effect. It should be noted that parallax effect methodologies require the system 10 to have multiple image sensors 18.

The sensory integration therapy system 10 still further includes a computer interaction engine 25 operable for inserting an abstraction related to the one or more users 24 and/or the background. The computer interaction engine 25 is optionally a program component within a runtime software environment operating on a personal computer or the like. The computer interaction engine 25 understands interactions between the one or more users 24 and/or the background and creates audio/visual signals in response to them. In this manner, the computer interaction engine 25 connects the computer vision engine 22 and a computer rendering engine 26 operable for modifying the created or projected artistic image in response to the presence and/or motion of the one or more users 24, thereby providing user interaction with the created or projected artistic image in a virtual environment. The computer rendering engine 26 is optionally a program component within a runtime software environment operating on a personal computer or the like. Again, all of this takes place in real time, i.e. between about 1/30^{th} and 1/60^{th} of a second.

In an embodiment where the computer vision engine 22, computer interaction engine 25, and computer rendering engine 26 are optionally program components within a runtime software environment operating on a personal computer or the like, with a control center (CPU) 31, minimal hardware requirements are suggested for the personal computer. The minimum hardware requirements are listed in Table 1.

Table 1, Minimum Hardware Requirements, lists the personal computer hardware requirements for implementing the computer vision engine 22, computer interaction engine 25, and computer rendering engine 26 components of the sensory integration therapy system 10 within a runtime software environment operating on a personal computer.

TABLE 1
MINIMUM HARDWARE REQUIREMENTS

| | |
|---|---|
| CPU | Genuine Intel Processor Pentium 4 3 GHz |
| HDD | Two (2) 120 GB 7200 RPM SATA in RAID 1 configuration |
| Memory | 256 MB DDR |
| USB | One (1) USB 2.0 port for camera connectivity, and three (3) |
| | USB 1.0 ports for other system peripherals |
| Video | nVidia nv45 GPU (the 6800 series has this GPU) and |
| Card | 256 MB video memory |

Table 2, Sample Configuration #1, lists known personal computer hardware used and tested in the sensory integration therapy system 10 wherein the computer vision engine 22, computer interaction engine 25, and computer rendering engine 26 operate within a runtime software environment operating on a personal computer.

TABLE 2
SAMPLE CONFIGURATION #1

| | |
|---|---|
| Case | Shuttle SB75G2 Socket 478 Intel Pentium 4/Celeron |
| | INTEL 875P |
| HDD | 2 SAMSUNG SpinPoint P Series SP1213C 120 GB 7200 |
| | RPM Serial ATA150 Hard Drive in a Mirrored |
| | Raid (RAID1) |
| Memory | 2 CORSAIR ValueSelect 512 MB 184-Pin DDR SDRAM |
| | DDR 400 (PC 3200) Unbuffered |
| CPU | Intel Pentium 4 3.0E Prescott 800 MHz FSB Socket |
| | 478 Processor |
| Video | PNY VCG6800GAPB Geforce 6800GT 256 MB |
| Card | GDDR3 AGP 4X/8X |

Table 3, Sample Configuration #2, lists known personal computer hardware used and tested in the sensory integration therapy system 10 wherein the computer vision engine 22, computer interaction engine 25, and computer rendering engine 26 operate within a runtime software environment operating on a personal computer.

TABLE 3
SAMPLE CONFIGURATION #2

| | |
|---|---|
| Case | Shuttle SB81P Socket T(LGA775) Intel Pentium 4/Celeron |
| | INTEL 915G |
| HDD | 2 SAMSUNG SpinPoint P Series SP1213C 120 GB |
| | 7200 RPM Serial ATA150 Hard Drive in a |
| | Mirrored Raid (RAID1) |
| Memory | 2 CORSAIR ValueSelect 512 MB 184-Pin DDR SDRAM |
| | DDR 400 (PC 3200) Unbuffered |
| CPU | Intel Pentium 4 530J Prescott 800 MHz FSB LGA 775 |
| | Processor |
| Video | eVGA 256-P2-N376-AX Geforce 6800GT 256 MB |
| Card | GDDR3 PCI-Express x16 |

Finally, the sensory integration therapy system 10 includes an auditory input routine/device 28 operable for providing auditory input that coincides with the visual input described above, an auditory output routine/device 29 operable for providing auditory output that coincides with the visual output described above, and a control center (CPU) 31 operable for controlling and coordinating the operation of all of the other components of the system 10.

In an alternative embodiment of the present invention, the sensory integration therapy system 10 includes a physical input and/or output device 33 (i.e. a “play device”) operable for allowing the one or more users 24 to physically interact with the created or projected artistic image and/or each other in the virtual environment, thereby providing staged or progressive means for interacting with the system 10 for users 24 who may respond better or prefer such means.

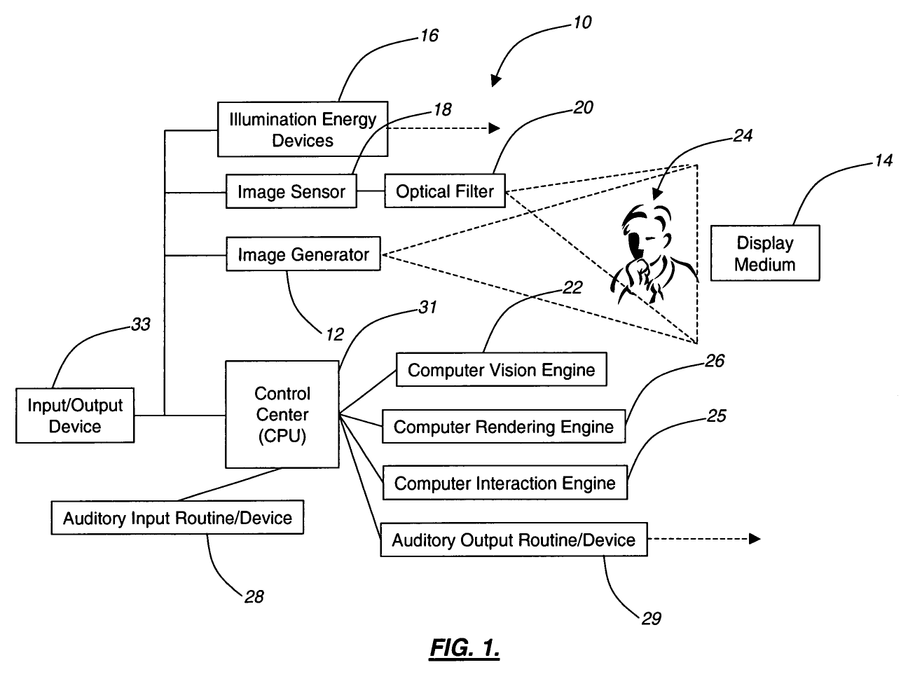

In another exemplary embodiment of the present invention, a sensory integration therapy method 30 for use in the treatment of developmental, emotional, psychiatric, and physical disabilities includes providing an image generator 12 (FIG. 1) operable for creating or projecting an artistic image. (Block 32). The image generator 12 is, for example, a visible light projector or the like. Various artistic images that are projected one at a time include, but are not limited to, water, where movement of a user's body sends realistic waves and ripples through a sheet of liquid fun; smoke fireballs, where a user's body may inject billowing smoke into the air and shoot fireballs from outstretched hands; trees, where a user enjoys a sublime experience in creating realistic limbs, branches, and twigs from the body and outstretched arms, transforming one temporarily into a beautiful tree; and a solar system, where a user may imagine the body as a titan while manipulating planets with outstretched arms and hands. Other artistic images that are projected may include, but are not limited to, billiards, revelation images, a mesmerizing spectrum, a shufflepuck game, a soccer game, a volleyball game, snowman creation, snowball fight, and an avalanche of balls.

In one embodiment the method includes a NEC MT1075 multi-purpose projection system for the image generator 12. The NEC MT1075 multi-purpose projection system is known in the art and is commercially available. This image generator 12 includes a power zoom/focus lens and a 300-watt lamp and produces an image size between 25 inches and 500 inches. This image generator 12 has an exceptional brightness level of 4,200 ANSI lumens, auto focus, auto wall color correction, and auto 3D reform, each making the interactive imaging experience more realistic for the sensory integration user undergoing habilitative therapy or rehabilitative therapy. Furthermore, this image generator 12 has an array of input and output terminals for quick and easy connectivity with other components of the overall sensory integration therapy system 10. For example, the image generator 12 includes a digital visual interface digital only (DVI-D) port with which a DVI cable connects the image generator 12 to the computer vision engine 22, computer interaction engine 25, and computer rendering engine 26. In addition to the array of input and output terminals, this image generator 12 may be controlled wirelessly from a remote control device and also optionally connects wirelessly to the computer vision engine 22, computer interaction engine 25, and computer rendering engine 26.

Optionally, the method 30 also includes providing a display medium 14 (FIG. 1) operable for receiving and displaying the created or projected artistic image. (Block 34). The display medium 14 may consist of a two or three-dimensional projection screen, a wall or other flat surface, a plasma screen, a rear-projection system, a hyper-bright OLED surface (possibly sprayed-on as a flexible substrate and onto the surface of which images are digitally driven), or the like. In general, the method 30 is display agnostic.

The method 30 further includes providing one or more illumination energy devices 16 (FIG. 1) operable for flooding a field of view in front of the created or projected artistic image with illumination energy. (Block 36). For example, the one or more illumination energy devices 16 may consist of one or more infrared lights operable for flooding the field of view in front of the created or projected artistic image with infrared light of a wavelength of between about 700 nm and about 1,000 nm. Preferably, the infrared light consists of near-infrared light of a wavelength of between about 700 nm and about 1,000 nm. Optionally, the infrared light consists of structured (patterned) infrared light or structured (patterned) and strobed infrared light, produced via light-emitting diodes or the like. In an alternative exemplary embodiment of the present invention, the image generator 12 and the one or more illumination energy devices 16 are integrally formed and utilize a common illumination energy source.

In one embodiment the method includes Lorex™ model VQ2120 infrared LED lamps for the illumination energy devices 16. The LorexTM model VQ2120 infrared LED lamp system is known in the art and is commercially available. A Lorex™ model VQ2120 infrared LED lamp system includes a sixty-eight power, 0 Lux, infrared LED lamp (comprises 68 LED illumination sensors), a 700 mA, 12-volt DC power source, a “Y” connector, and a mounting system. The “Y” connector allows a user to split the 12-volt DC power source between multiple illumination energy devices 16. The Lorex™ model VQ2120 infrared LED lamps emit infrared light at a wavelength of 850 nm (75 mm diameter), covering an illumination angle of approximately fifty to sixty degrees. The 12-volt DC power source plugs into a commercial electrical source. The “Y” connector's DC plug connects to the other end of the 12-volt DC power source. One or more infrared LED lamps are then plugged into the “Y” connector using the IN jack on each infrared LED lamp. A single infrared LED lamp is connected to the 12-volt DC power source without using the “Y” connector. These components comprise the illumination energy devices 16 used in the sensory integration therapy system 10 in this embodiment. The illumination energy devices 16 do not connect to the image sensor 18; however, optimal performance is obtained when the illumination energy devices 16 are placed a close as possible as the image sensor 18, and pointing in the same direction as the image sensor 18.

The method 30 still further includes providing an image sensor 18 (FIG. 1) operable for detecting the illumination energy. (Block 38). The image sensor 18 is, for example, an infrared camera or the like. In an alternative exemplary embodiment of the present invention, the image generator 12 and the image sensor 18 are integrally formed.

In one embodiment the method includes a Lumenera Corporation Lu070 high speed USB 2.0 (480 Mbits/sec) camera for the image sensor 18. The Lumenera Corporation Lu070 camera is known in the art and is commercially available. This image sensor 18 captures images at 60 frames per second at a resolution of 640×480 pixels, 7.4 um square pixels. The image sensor 18 is based on a one-third inch, 5.8 mm×4.9 mm array, charge-coupled device (CCD) sensor with a fast global electronic shutter, which is ideal for capturing objects in motion in an interactive imaging experience. This image sensor 18 ideally maintains low light sensitivity to provide image capture even in low light conditions. This is ideal in a sensory integration therapy system 10 wherein the lighting is optionally and intentionally low in order to provide better viewing of the projected images on the display medium 14. The image sensor 18 connects to the computer vision engine 22, computer interaction engine 25, and computer rendering engine 26 via a high-speed USB 2.0 (480 Mbits/sec) connector.

Optionally, an optical filter 20 (FIG. 1) is coupled with the image sensor 18 and is operable for filtering out illumination energy of a predetermined wavelength or wavelength range, such as, for example, visible light.

In one embodiment the method includes an X-Nite 780 nm×2 mm thick infrared band pass, visible light blocking filter, in 30 mm diameter, for an optical filter 20. This X-Nite 780 nm, 30 mm optical filter 20 is known in the art and is commercially available. The optical filter 20 is constructed of optical precision ground and polished glass that is ISO2002 compliant. Such an optical filter 20 blocks all light in the visible spectrum and only allows a band of infrared light to pass. The threshold cutoff value for what light passes is the 780 nm wavelength.

The method 30 still further includes providing a computer vision engine 22 (FIG. 1) operable for detecting one or more users 24 (FIG. 1) in the field of view in front of the created or projected artistic image and segmenting the one or more users 24 and a background, thereby providing markerless or markered motion capture. (Block 40). The computer vision engine 22 is optionally a program component within a runtime software environment operating on a personal computer, or the like, having an operating system. The computer vision engine 22 gives the system 10 (FIG. 1) “sight” and provides an abstraction of the one or more users 24 and the background. In this manner, the one or more users 24 and the background are separated and recognized. When properly implemented, the number of users 24 can be determined, even if there is overlap, and heads and hands may be tracked. Preferably, all of this takes place in real time, i.e. between about 1/30^{th} and 1/60^{th} of a second. Optionally, the computer vision engine 22 is operable for detecting the one or more users 24 in the field of view in front of the created or projected artistic image and segmenting the one or more users 24 and the background, thereby providing markerless or markered motion capture, utilizing the parallax effect. It should be noted that parallax effect methodologies require the system 10 to have multiple image sensors 18.

The method 30 still further includes providing a computer interaction engine 25 (FIG. 1) operable for inserting an abstraction related to the one or more users 24 and/or the background. The computer interaction engine 25 is optionally a program component within a runtime software environment operating on a personal computer or the like. The computer interaction engine 25 understands interactions between the one or more users 24 and/or the background and creates audio/visual signals in response to them. In this manner, the computer interaction engine 25 connects the computer vision engine 22 and a computer rendering engine 26 (FIG. 1) operable for modifying the created or projected artistic image in response to the presence and/or motion of the one or more users 24, thereby providing user interaction with the created or projected artistic image in a virtual environment. (Block 42). The computer rendering engine 26 is optionally a program component within a runtime software environment operating on a personal computer or the like. Again, all of this takes place in real time, i.e. between about 1/30^{th} and 1/60^{th} of a second.

Finally, the method 30 includes providing an auditory input routine/device 28 (FIG. 1) operable for providing auditory input that coincides with the visual input described above, an auditory output routine/device 29 (FIG. 1) operable for providing auditory output that coincides with the visual output described above, and a control center (CPU) 31 (FIG. 1) operable for controlling and coordinating the operation of all of the other components of the system 10.

In an alternative embodiment of the present invention, the method 30 includes providing a physical input and/or output device 33 (FIG. 1) (i.e. a “play device”) operable for allowing the one or more users 24 to physically interact with the created or projected artistic image and/or each other in the virtual environment, thereby providing staged or progressive means for interacting with the system 10 for users 24 who may respond better or prefer such means.

In a simplified exemplary embodiment of the present invention, a sensory integration therapy method for use in the treatment of developmental, emotional, psychiatric, and physical disabilities includes creating or projecting an artistic image; detecting one or more users in a field of view in front of the created or projected artistic image and segmenting the one or more users and a background, thereby providing markerless or markered motion capture; and modifying the created or projected artistic image in response to the presence and/or motion of the one or more users, thereby providing user interaction with the created or projected artistic image in a virtual environment.

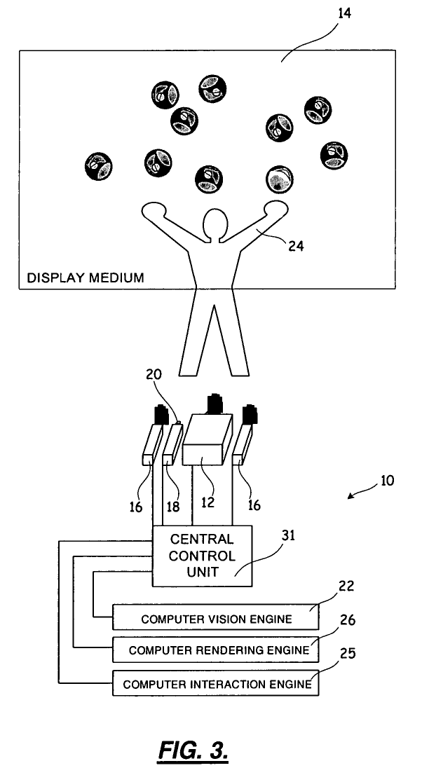

Referring now to FIG. 3, a schematic diagram illustrating the sensory integration therapy system of the present invention and a user's rehabilitative therapy interactive imaging experience is shown. A display medium 14, such as a projection screen, or the like, is illustrated. A user 24 stands between the image generator 12 and the display medium 14. In this example, the user 24 is engaged in rehabilitative therapy for motor skills while playing virtual billiards. The sensory integration therapy system 10 includes an image generator 12 that projects a dynamic image of pool balls on the display medium 14 that freely move based on a user's 24 movement and interaction. The sensory integration therapy system 10 includes illumination energy devices 16 operable for flooding a field of view in front of the projected artistic image, interactive pool balls, with illumination energy, an image sensor 18, and an optical filter 20. The computer vision engine 22, the computer interaction engine 25, and the computer rendering engine 26 are program components within a runtime software environment operating on a personal computer having a central control unit 31. As the user 24 moves, the motions of the body, arms, and hands, etc. control the various movements of the pool balls as they are dynamically displayed on the display medium 14.

As used herein, markered motion capture refers to the use of sensor-detectable passive or active tracking devices associated with the one or more users that assist the vision system in deciphering the presence and/or motion of the one or users. For example, different color gloves may be worn by a user to assist the vision system in locating and tracking the user's hands. Likewise, RFID technology may be employed, etc.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the invention and are intended to be covered by the following claims.

What is claimed is:

1. A sensory integration therapy system for use in the treatment of developmental, emotional, psychiatric, and physical disabilities, comprising:
an image generator operable for creating or projecting an artistic image;
one or more illumination energy devices operable for flooding a field of view in front of the created or projected artistic image with illumination energy;
an image sensor operable for detecting the illumination energy;
a computer vision engine operable for detecting one or more users in the field of view in front of the created or projected artistic image and segmenting the one or more users and a background, thereby providing markerless or markered motion capture;
a computer interaction engine operable for inserting an abstraction related to the one or more users and/or the background; and
a computer rendering engine operable for modifying the created or projected artistic image in response to the presence and/or motion of the one or more users, thereby providing user interaction with the created or projected artistic image in a virtual environment; and
wherein the system is used for the treatment of developmental, emotional, psychiatric, and physical disabilities.

2. The sensory integration therapy system of claim 1, wherein the illumination energy comprises near-infrared light.

3. The sensory integration therapy system of claim 1, wherein the illumination energy comprises structured infrared light.

4. The sensory integration therapy system of claim 1, wherein the illumination energy comprises structured and strobed infrared light.

5. The sensory integration therapy system of claim 1, wherein the computer vision engine is operable for detecting the one or more users in the field of view in front of the created or projected artistic image and segmenting the one or more users and the background, thereby providing markerless or markered motion capture, utilizing the parallax effect.

6. The sensory integration therapy system of claim 1, further comprising an optical filter coupled with the image sensor operable for filtering out illumination energy of a predetermined wavelength or wavelength range.

7. The sensory integration therapy system of claim 1, wherein the computer vision engine, the computer interaction engine, and the computer rendering engine are program components within a runtime software environment operating on a personal computer.

8. A sensory integration therapy method for use in the treatment of developmental, emotional, psychiatric, and physical disabilities, comprising:
providing an image generator operable for creating or projecting an artistic image;
providing one or more illumination energy devices operable for flooding a field of view in front of the created or projected artistic image with illumination energy;
providing an image sensor operable for detecting the illumination energy;
providing a computer vision engine operable for detecting one or more users in the field of view in front of the created or projected artistic image and segmenting the one or more users and a background, thereby providing markerless or markered motion capture;
providing a computer interaction engine operable for inserting an abstraction related to the one or more users and/or the background; and
providing a computer rendering engine operable for modifying the created or projected artistic image in response to the presence and/or motion of the one or more users, thereby providing user interaction with the created or projected artistic image in a virtual environment; and
wherein the system is used for the treatment of developmental, emotional, psychiatric, and physical disabilities.

9. The sensory integration therapy method of claim 7, wherein the illumination energy comprises near-infrared light.

10. The sensory integration therapy method of claim 7, wherein the illumination energy comprises structured infrared light.

11. The sensory integration therapy method of claim 7, wherein the illumination energy comprises structured and strobed infrared light.

12. The sensory integration therapy method of claim 7, wherein the computer vision engine is operable for detecting the one or more users in the field of view in front of the created or projected artistic image and segmenting the one or more users and the background, thereby providing markerless or markered motion capture, utilizing the parallax effect.

13. The sensory integration therapy method of claim 7, further comprising providing an optical filter coupled with the image sensor operable for filtering out illumination energy of a predetermined wavelength or wavelength range.

14. The sensory integration therapy method of claim 7, wherein the computer vision engine, the computer interaction engine, and the computer rendering engine are program components within a runtime software environment operating on a personal computer.

15. A sensory integration therapy method for use in the treatment of developmental, emotional, psychiatric, and physical disabilities, comprising:
creating or projecting an artistic image;
detecting one or more users in a field of view in front of the created or projected artistic image and segmenting the one or more users and a background, thereby providing markerless or markered motion capture; and
modifying the created or projected artistic image in response to the presence and/or motion of the one or more users, thereby providing user interaction with the created or projected artistic image in a virtual environment; and
wherein the system is used for the treatment of developmental, emotional, psychiatric, and physical disabilities.

16. A sensory integration therapy method for use in the treatment of developmental, emotional, psychiatric, and physical disabilities, comprising:
creating or projecting an artistic image;
detecting one or more users in a field of view in front of the created or projected artistic image and segmenting the one or more users and a background, thereby providing markerless or markered motion capture; and
modifying the created or projected artistic image in response to the presence and/or motion of the one or more users, thereby providing user interaction with each other in a virtual environment; and
wherein the system is used for the treatment of developmental, emotional, psychiatric, and physical disabilities.

17. A sensory integration therapy system for use in the treatment of developmental, emotional, psychiatric, and physical disabilities, comprising:
an image generator operable for creating or projecting an artistic image;
one or more illumination energy devices operable for flooding a field of view in front of the created or projected artistic image with illumination energy;
an image sensor operable for detecting the illumination energy;
a computer vision engine operable for detecting one or more users in the field of view in front of the created or projected artistic image and segmenting the one or more users and a background, thereby providing markerless or markered motion capture;
a computer interaction engine operable for inserting an abstraction related to the one or more users and/or the background;
a computer rendering engine operable for modifying the created or projected artistic image in response to the presence and/or motion of the one or more users, thereby providing user interaction with the created or projected artistic image in a virtual environment; and
a physical input and/or output device operable for allowing the one or more users to physically interact with the created or projected artistic image and/or each other in the virtual environment; and
wherein the system is used for the treatment of developmental, emotional, psychiatric, and physical disabilities.

18. The sensory integration therapy system of claim 17, wherein the computer vision engine, the computer interaction engine, and the computer rendering engine are program components within a runtime software environment operating on a personal computer.
